(19) United States
(12) Patent Application Publication
(10) Pub. No.: US 2026/0222207 A1
(43) Pub. Date: Jul. 30, 2026

(54) SYSTEM AND METHOD FOR AUTHENTICATION OF OBJECTS AND RENDERING AUGMENTED REALITY CONTENT RELATIVE TO OBJECTS

(71) Applicants: Jacob Elmon, London (GB); Brandon Elmon, London (GB)

(72) Inventors: Jacob Elmon, London (GB); Brandon Elmon, London (GB)

(21) Appl. No.: 19/575,023

(22) Filed: Mar. 23, 2026

Related U.S. Application Data
(63) Continuation-in-part of application No. 18/513,709, filed on Nov. 20, 2023.
(60) Provisional application No. 63/427,572, filed on Nov. 23, 2022.

(51) Int. Cl. H04L 9/32; G06F 21/10; G06T 11/00

(52) U.S. Cl. CPC H04L 9/3213; G06F 21/1014; G06T 11/00

(57) ABSTRACT

A system and method are disclosed for authentication of objects and rendering augmented reality (AR) content relative to such objects. The system includes an object associated with a non-fungible token (NFT) and a smart tag configured to generate cryptographic codes at periodic intervals based on object-specific parameters and a device fingerprint. A user device detects the smart tag and transmits the cryptographic code to a computing device communicatively coupled with a blockchain network, a database, and AR devices. The blockchain network stores ownership, provenance, and metadata associated with the NFT. The computing device receives cryptographic codes and contextual data, verifies NFT ownership, validate the cryptographic code, and evaluate contextual conditions. Upon authentication, the computing device dynamically generates context-aware AR content using stored rules and user interaction data, and transmits AR broadcast information to user devices and AR devices to enable rendering of the content relative to the object.

### CROSS REFERENCE TO RELATED APPLICATIONS

The present application is a continuation-in-part of the U.S. Patent Application No. U.S. Ser. No. 18/513,709, filed on Nov. 20, 2023, which derives priority from US Provisional patent application No. U.S. 63/427,572 filed on Nov. 23, 2022, and the contents of which are hereby incorporated by reference in their entirety.

### TECHNICAL FIELD

The present invention generally relates to authentication of augmented reality enabled objects in association with blockchain and non-fungible tokens (NFT). More particularly, the present invention relates to a system and method for authentication of objects using non-fungible tokens and for rendering augmented reality content relative to authenticated objects based on cryptographic verification, contextual data, and multi-user interaction.

### BACKGROUND

Augmented reality (AR) technologies have been increasingly utilized to associate digital content with physical objects, enabling users to visualize virtual elements in real-world environments. Such systems are being explored across various applications with the aim of enhancing user engagement and experiential value.

Despite these developments, existing AR implementations commonly rely on static identification mechanisms, such as scannable codes or short-range communication tags, to initiate AR experiences. In typical use, a user or an external device must deliberately perform a scanning or detection action to access associated AR content. This interaction model introduces dependency on user effort, limits the natural flow of interaction, and constrains usability to specific conditions or proximity ranges.

Moreover, since such identification mechanisms are generally fixed and externally accessible, they may be susceptible to duplication or unauthorized reuse, thereby affecting reliability in practical deployments. Further, conventional AR systems are predominantly designed around on-demand activation, where AR content is rendered only after explicit interaction by a viewing device. This approach does not scale efficiently in situations involving multiple users or dynamic movement. As a result, existing systems do not fully address the need for seamless, intuitive, and scalable AR interaction in real-world settings.

Further, a few patent references related to the aforementioned technology are discussed below.

US20230245086A of Alex Boghossian et al., entitled “Multi-Sensory/Phygital (Physical & Digital) Cannabis Magazine” discloses a method of selecting, purchasing and receiving a Cannabis product by a consumer. The method involves purchasing a Cannabis-related magazine; downloading a Cannabis-related software application on mobile communication device; initiating operation, at the mobile communication device, of the Cannabis-related software application; and/or scanning a QR code on a page of the Cannabis-related magazine, utilizing a camera of the mobile communication device. The method further includes downloading digital content files associated with the Cannabis strain to the mobile communication device thought the QR code; displaying the digital content files associated with the Cannabis strain on a monitor or screen of the mobile communication device; and receiving an identifier indicating the Cannabis-related magazine is associated with a non-fungible token (NFT).

US20250085669A1 of Jacob Elmon et al. entitled “novel method of linking a wearable device for hyper reality visualization” discloses a method and system for hyper reality visualization. The system involves integration of NFC or RFID tags within a wearable device to generate an electromagnetic biofield or hyper reality field around a user. The hyper reality field is visualized by augmented reality (AR) compatible smartphones, virtual reality (VR) glasses, or VR headsets to create an interactive and immersive AR environment. The NFC or RFID tags are linked to a unique non-fungible token (NFT) providing authentication, ownership, and verification of digital assets. A software application enables access to AR content and facilitates sharing of gaming experiences, rewards, leaderboards, social interactions, and multiplayer interactions, including scanning and exchanging virtual items.

However, the aforementioned references exhibit several technical limitations. In particular, the disclosed approaches rely on static identifiers such as NFC or RFID tags, which provide only basic linkage to assets and do not ensure robust authentication of the physical item. Such identifiers may be susceptible to duplication, cloning, or unauthorized reuse, thereby reducing reliability in distinguishing genuine assets from imitations.

Further, the existing references rely on a trigger-based interaction model wherein AR content is made available only upon deliberate activation by a viewing device. Such approaches do not support continuous or ambient visibility of AR content in real-world environments and are not well-suited for scenarios involving multiple users or dynamic movement, thereby limiting scalability and seamless real-time interaction.

Therefore, there is a need for a system and method for enabling secure and reliable association between physical items and digital assets, while overcoming the limitations of static identification mechanisms, and further facilitating seamless, scalable, and continuous AR interaction in real-world environments, particularly in scenarios involving multiple users and dynamic conditions.

### SUMMARY

The present invention discloses a system and method for authentication of objects and rendering augmented reality content relative to objects. The system comprises at least one object comprising a smart tag. The object is associated with a Non-Fungible Token (NFT). The smart tag optionally comprises at least one sensor node, and the object comprises at least one of physical object and digital object. The smart tag is configured to generate cryptographic code at periodic intervals based one or more parameters associated with the object and device fingerprint associated with the smart tag. The system further comprises at least one user device associated with a user. The system further comprises a database configured to store augmented reality content data associated with the object, rules data for generating augmented reality content, user interaction data and multi-user interaction data. The system further comprises a blockchain network configured to store ownership data of the non-fungible token including an identifier associated with the non-fungible token, provenance data including transaction history and ownership records associated with the non-fungible token and metadata associated with the non-fungible token. The system further comprises one or more augmented reality devices, and a computing device in communication with the blockchain network, the database and the user device via a network.

The computing device comprises a memory storing a set of program modules and a processor configured to execute the program modules. The program modules comprise an input module configured to receive the cryptographic code via the user device based on detection of the smart tag, and an authentication module configured to verify ownership of the non-fungible token associated with the object using the blockchain network. The input module is further configured to receive contextual data including environmental data, sensor data, and proximity data associated with one or more objects from at least one user device. The authentication module is further configured to determine whether predefined authentication conditions are satisfied. The predefined authentication conditions include verification of ownership of the non-fungible token, validation of the cryptographic code, and evaluation of the contextual data. The modules further comprise an augmented reality module configured to generate augmented reality content associated with the object upon satisfaction of the predefined authentication conditions. The augmented reality content is context-aware and dynamically generated. The augmented reality module is configured to generate and transmit an augmented reality (AR) broadcast information to the user device. The augmented reality module enables the user device to initiate outward transmission of an augmented reality (AR) broadcast information via a wireless communication protocol. The AR devices is configured to receive AR broadcast information and render the augmented reality content data relative to the object.

In one embodiment, the wireless communication protocol is a short-range wireless communication protocol including Bluetooth Low Energy (BLE). In one embodiment, the object includes at least one of physical garment and digital garment. In one embodiment, the parameters include motion data, environmental data, characteristics data of the physical garment. The sensor node is configured to capture the motion data, environmental data, characteristics data of the physical garment.

The smart tag comprises a memory module storing a set of program modules and cryptographic data, and a processor configured to execute the program modules. The program modules comprise a tamper detection module configured to detect a tampering condition associated with the smart tag. In response to the tampering condition, the tamper detection module is configured to erase stored cryptographic data and transmit a tamper notification for updating a status of the non-fungible token associated with the garment as compromised.

The smart tag comprises at least one of a near field communication (NFC) tag, a radio frequency identification (RFID) tag, a Bluetooth low energy (BLE) transmitter, and a quick response (QR) code associated with the garment. The smart tag is configured to emit optical markers and magnetic signals to generate a spatially detectable identity field associated with the garment. The computing device is configured to detect the spatially detectable identity field to localize the augmented reality content relative to the garment via the user device. In one embodiment, the augmented reality (AR) broadcast information includes spatial anchor data to localize the augmented reality content relative to the garment.

The computing device enables the user device to at least one of continuously and periodically transmit augmented reality (AR) broadcast information to one or more AR devices proximal to the user device. The AR broadcast information includes a cryptographic proof of ownership of a non-fungible token, the augmented reality content data, spatial anchor data and permission data.

Upon authentication of the user, the computing device enables the user device to control and modify the AR content data displayed relative to the garment in real time, and allow the user to selectively define one or more AR content data to be broadcast to nearby AR devices. The rendering of the AR content data applies to both physical garments and digital garments.

In one embodiment, the augmented reality device comprises AR glasses. The augmented reality device is configured to continuously scan for AR broadcast information from one or more nearby user devices via short-range wireless communication, receive the AR broadcast information comprising a cryptographic proof of ownership of the non-fungible token, extract and verify the cryptographic proof against a blockchain record in real time without user input, discard AR broadcast signals that fail verification or are determined to be tampered, receive continuous positional update data associated with a broadcasting user device, perform visual body pose estimation of a corresponding user wearing the garment using one or more onboard imaging sensors, fuse the positional update data and the body pose estimation data to maintain spatial registration, and render augmented reality content only upon successful verification. The augmented reality content is continuously anchored to one or more body keypoints of the corresponding user during movement, thereby maintaining spatial stability relative to the corresponding user independent of movement of the augmented reality device.

In another embodiment, the augmented reality device is configured to detect AR broadcast signals from a plurality of user devices in a shared environment, verify each broadcast signal based on a cryptographic proof associated with a corresponding non-fungible token, rank verified broadcast signals based on proximity of corresponding user devices, render augmented reality content data associated with broadcast signals within a predefined proximity threshold at a first rendering fidelity, adjust rendering of augmented reality content data associated with broadcast signals beyond the predefined proximity threshold by reducing visibility, enforce visibility permissions associated with each broadcast signal based on permission data, and render one or more additional AR content layers within a spatial region associated with each broadcast signal based on permissions granted by a corresponding user of the non-fungible token.

The authentication module is configured to perform zero-knowledge proof-based verification of ownership of the non-fungible token to confirm ownership without revealing wallet identity information associated with the user. The AR module is configured to dynamically generate augmented reality content based on garment metadata, environmental data, and user interaction history associated with the user device. The computing device is further configured to detect proximity of one or more additional garments associated with respective non-fungible tokens and generate interactive augmented reality content data based on multi-user interaction between the garments via the AR module. Further, the augmented reality content data comprises collaborative visual effects generated when two or more garments associated with verified non-fungible tokens are detected within a predefined proximity region.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for authentication of objects and rendering augmented reality content relative to objects, according to an embodiment of the present invention.

FIG. 2 exemplarily illustrates a block diagram of a smart tag associated with objects or garments, according to an embodiment of the present invention.

FIG. 3 exemplarily illustrates a block diagram of a computing device and connection of the computing device to the components of the system, according to an embodiment of the present invention.

FIG. 4 exemplarily illustrates a flowchart of a method for authentication of objects and rendering augmented reality content relative to objects, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

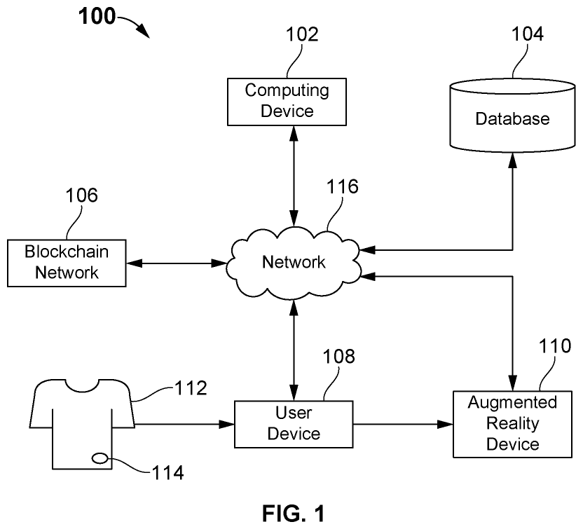

FIG. 1 exemplarily illustrates an environment 100 of a system for authentication of objects 112 and rendering augmented reality content relative to objects 112, according to an embodiment of the present invention. The system comprises at least one computing device 102, at least one database 104 in communication with the computing device 102, and a blockchain network 106 in communication with the computing device 102. The system further comprises at least one user device 108 associated with a user, one or more augmented reality (AR) devices 110, and at least one object 112 comprising a smart tag 114. The computing device 102, the database 104, the blockchain network 106, the user device 108, and the AR devices 110 are in communication via a network 116.

The smart tag 114 is associated with the object 112 and is configured to generate a cryptographic code at periodic intervals based on one or more parameters associated with the object 112 and a device fingerprint associated with the smart tag 114. In one embodiment, the object 112 includes, but not limited to, at least one of physical garment and digital garment

The user device 108 is configured to detect the smart tag 114 and receive the cryptographic code associated with the object 112. The user device 108 is further configured to communicate with the computing device 102 via the network 116. In one embodiment, the user device 108 comprises an application configured to enable interaction with the computing device 102 for authentication and augmented reality content processing. The blockchain network 106 is configured to store ownership data of the non-fungible token associated with the object 112, including an identifier associated with the non-fungible token, provenance data including transaction history and ownership records, and metadata associated with the non-fungible token. The blockchain network 106 enables verification of ownership of the non-fungible token during authentication.

The database 104 is in communication with the computing device 102 and is configured to store augmented reality content data associated with the object 112, rules data for generating augmented reality content, user interaction data, and multi-user interaction data. In one embodiment, the database 104 resides within the computing device 102. In another embodiment, the database 104 resides remotely from the computing device 102.

The “augmented reality content data” refers to digital content associated with the object 112, including visual elements, animation parameters, rendering instructions, spatial anchoring data, and asset files configured to be rendered by an augmented reality device 110 relative to the object 112. The “procedural rules or rules data” refer to a set of predefined or dynamically generated instructions, algorithms, or logic configured to modify, generate, or adapt augmented reality content based on contextual inputs associated with the object 112 and the user.

The “contextual data” refers to real-time or near real-time data associated with the object 112 and surrounding environment, including: environmental data comprising ambient light and temperature; sensor data comprising motion, orientation, and position; and proximity data comprising presence and relative distance of one or more additional objects 112 or users.

The “user interaction data” refers to data generated from interactions performed by a user with the object 112 or the augmented reality content, including gestures, inputs, selections, and movement patterns. The user interaction data further includes a user session including session state, authentication state, interaction history, and temporal activity data. The “multi-user interaction data” refers to data associated with interactions between a plurality of users and corresponding objects 112, including synchronization data, shared state data, interaction events, and collaborative engagement data in a shared augmented reality environment.

The network 116 represents one or more interconnected communication networks over which the computing device 102, the database 104, the blockchain network 106, the user device 108, and the AR devices 110 communicate. The network 116 may include packet-based networks, local area networks, wireless networks, cellular networks, or combinations thereof. The network 116 may be implemented as a wired network, a wireless network, or a combination thereof.

The computing device 102 may include at least one of a server, a general-purpose computer, a special-purpose computer, or a distributed computing system. Although illustrated as a single device, the functions of the computing device 102 may be performed by multiple computing devices operating in a distributed environment. In one embodiment, the computing device 102 may be integrated with the user device 108. The computing device 102 is configured to receive the cryptographic code from the user device 108, verify ownership of a non-fungible token associated with the object 112 using the blockchain network 106, and determine whether predefined authentication conditions are satisfied. The computing device 102 is further configured to receive contextual data including environmental data, sensor data, and proximity data associated with one or more objects 112 from the user device 108, and generate augmented reality content data associated with the object 112 based on the contextual data.

The computing device 102 is further configured to generate augmented reality (AR) broadcast information and transmit the augmented reality broadcast information to the user device 108. The user device 108 is configured to transmit the augmented reality broadcast information via a wireless communication protocol to one or more AR devices 110. The AR devices 110 are configured to receive the augmented reality broadcast information and render augmented reality content data relative to the object 112.

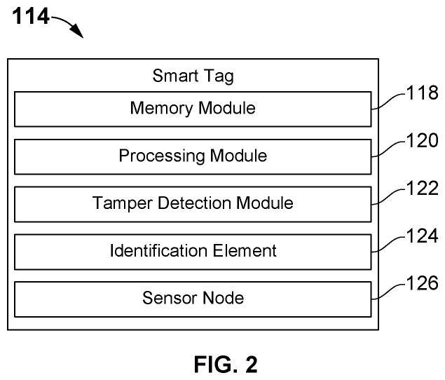

Referring to FIG. 2, the smart tag 114 comprises a memory module 118 storing a set of program modules and cryptographic data, and a processing module 120 configured to execute the program modules. The program modules comprise a tamper detection module 122. The smart tag 114 comprises at least one identification element 124 and, optionally, at least one sensor node 126. The identification element 124 is configured to enable detection of the smart tag 114 by the user device 108 and comprises at least one of a near field communication (NFC) tag, a radio frequency identification (RFID) tag, a Bluetooth low energy (BLE) transmitter, and a quick response (QR) code associated with the object 112. The sensor node 126 is configured to capture one or more parameters associated with the object 112, including motion data, environmental data, and characteristics data of the object 112. The sensor node 126 includes an inertial measurement unit and environmental sensing elements. In one embodiment, the sensor node 126 comprises one or more sensors configured to detect movement, orientation, ambient conditions, and physical characteristics of the object 112.

The processing module 120 is configured to generate a cryptographic code at periodic intervals based on the one or more parameters captured by the sensor node 126 and a device fingerprint associated with the smart tag 114. The cryptographic code is stored in the memory module 118 and is transmitted via the identification element 124 for detection by the user device 108. The tamper detection module 122 is configured to detect a tampering condition associated with the smart tag 114, including physical intrusion, detachment, or structural alteration. Upon detection of the tampering condition, the processing module 120 is configured to erase the cryptographic data stored in the memory module 118 and transmit a tamper notification for updating a status of the non-fungible token associated with the object 112 as compromised. In one embodiment, the smart tag 114 is further configured to emit optical markers and magnetic signals to generate a spatially detectable identity field associated with the object 112. The spatially detectable identity field is configured to enable localization of augmented reality content relative to the object 112. In one embodiment, the spatially detectable identity field is detected using one or more sensing components of the AR device 110 including magnetic field sensors or imaging sensors.

In one embodiment, the smart tag 114 is configured to generate a spatially detectable identity field associated with the object 112 using low-power magnetic pulses and optical markers. The low-power magnetic pulses are generated via one or more radio frequency identification or near field communication elements, and the optical markers comprise infrared micro-light emitting elements or reflective micro-patterns associated with the object 112. The spatially detectable identity field ensures that augmented reality content is spatially bound to the object 112 and prevents replication by unauthorized devices. The spatially detectable identity field provides a measurable field for localization of augmented reality content relative to the object 112, thereby avoiding reliance on abstract augmented reality overlays.

The system as described with reference to FIG. 1 and FIG. 2 provides a multi-layer authentication framework for rendering augmented reality content relative to objects 112. The smart tag 114 is embedded within or associated with the object 112. The smart tag 114 is configured to generate the cryptographic code. The cryptographic code is a physically-derived cryptographic signature based on the motion data, environmental data, and characteristics data associated with the object 112. The smart tag 114 is further configured to emit optical markers and magnetic signals to generate the spatially detectable identity field associated with the object 112. The spatially detectable identity field is detectable by the AR devices 110 for localization of augmented reality content.

The user device 108 and the AR devices 110 are configured to detect the smart tag 114 and obtain an identifier associated with the non-fungible token. The computing device 102 is configured to verify ownership of the non-fungible token using the blockchain network 106. The verification may optionally be performed using zero-knowledge proof based mechanisms to confirm ownership without revealing wallet identity information associated with the user. The computing device 102 is further configured to implement a multi-factor authentication process based on a combination of the cryptographic code, ownership verification of the non-fungible token, and contextual data associated with the object 112. The contextual data comprises environmental data, sensor data, and proximity data received from the user device 108. The contextual data is used to evaluate predefined authentication conditions prior to enabling augmented reality content rendering.

The contextual data includes environmental data comprising ambient light conditions, location data, and environmental triggers, sensor data comprising motion, orientation, and gesture data associated with the object 112 and user, and proximity data comprising detection of one or more additional objects 112 associated with respective non-fungible tokens. The computing device 102 is configured to process the contextual data to dynamically adapt the augmented reality content.

The computing device 102 is configured to generate augmented reality content data based on metadata associated with the non-fungible token, the contextual data, and user interaction data associated with the user device 108. The augmented reality content data is dynamically generated based on procedural rules stored in the database 104.

The database 104 is configured to store the augmented reality content data, rules data for generating augmented reality content, user interaction data, and multi-user interaction data. The computing device 102 retrieves the augmented reality content data and applies the rules data to generate context-aware augmented reality content.

The computing device 102 is further configured to detect proximity of one or more additional objects 112 associated with respective non-fungible tokens and generate interactive augmented reality content data based on multi-user interaction between the objects 112. The augmented reality content data comprises collaborative visual effects generated when two or more objects 112 associated with verified non-fungible tokens are within a predefined proximity region.

The computing device 102 is further configured to generate augmented reality broadcast information comprising a cryptographic proof of ownership of the non-fungible token, augmented reality content data, spatial anchor data, and permission data. The user device 108 is configured to transmit the augmented reality broadcast information to one or more AR devices 110 via a wireless communication protocol. In one embodiment, the user device 108 is configured to transmit the augmented reality broadcast information to one or more AR devices 110 via a wireless radio transceiver.

The AR devices 110 are configured to receive the augmented reality broadcast information, verify the cryptographic proof of ownership, and render augmented reality content relative to the object 112 based on the spatial anchor data. The AR devices 110 are further configured to enforce permission data associated with the augmented reality broadcast information to control visibility and rendering of augmented reality content.

The computing device 102 is further configured to enable the user associated with the user device 108 to control and modify augmented reality content data in real time via a graphical user interface rendered on a display of the user device 108 and selectively define augmented reality content data for transmission to nearby AR devices 110. The augmented reality content data is rendered relative to both physical garments and digital garments.

In one embodiment, the augmented reality content data comprises

multiple content layers. One or more additional augmented reality content layers are rendered within a spatial region associated with the object 112 based on permissions granted by the user associated with the non-fungible token.

The smart tag 114, in combination with the computing device 102 and the blockchain network 106, enables cryptographically-gated activation of augmented reality content. The rendering of the augmented reality content is conditioned upon successful validation of the cryptographic code and ownership of the non-fungible token, thereby preventing unauthorized access and replication. The tamper detection module 122 of the smart tag 114 is configured to detect tampering conditions including physical intrusion, detachment, or structural damage. Upon detection of the tampering condition, the cryptographic data is erased and a tamper notification is transmitted for updating a status of the non-fungible token associated with the object 112 as compromised.

In one embodiment, the computing device 102 is further configured to utilize user interaction data and multi-user interaction data to adapt augmented reality content based on user behavior, interaction patterns, and proximity of other users, thereby enabling personalized and interactive augmented reality experiences. The system as described provides a modular architecture supporting software-based implementations and hardware-augmented embodiments, wherein the combination of cryptographic authentication, contextual data processing, and spatially anchored augmented reality rendering enables secure, scalable, and interactive augmented reality experiences associated with objects 112.

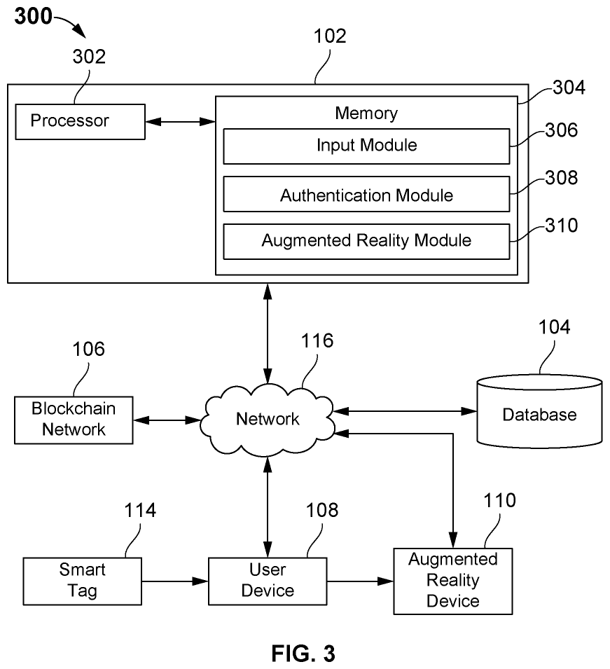

In another embodiment, the contextual data comprises environmental data captured via the user device 108. The environmental data includes ambient light conditions obtained from one or more imaging sensors, location data obtained from positioning sensors, and environmental triggers obtained from external data sources. The environmental data may be captured using one or more sensors associated with the user device 108, including camera-based sensors configured to detect ambient light conditions, positioning modules configured to determine geographic location, and external interfaces configured to obtain environmental conditions. Referring to FIG. 3, the computing device 102 is configured to utilize the environmental data to dynamically adapt augmented reality content data generated via the augmented reality module 310.

The sensor data may be captured using one or more motion sensors including accelerometers, gyroscopes, and imaging sensors configured to perform motion tracking and gesture detection. The computing device 102 is configured to analyze the sensor data to determine movement, posture, and interaction patterns associated with the object 112 and the user. The computing device 102 is configured to generate augmented reality content data that dynamically responds to the environmental data and the sensor data. The augmented reality content data comprises procedural visual effects, animation variations, and visual transformations that adapt in real time based on changes in environmental conditions and movement of the object 112.

In one embodiment, the computing device 102, via the augmented reality module 310, is configured to generate augmented reality content data dynamically based on a combination of metadata associated with the non-fungible token, environmental inputs, user interaction data, and multi-user context. The metadata associated with the non-fungible token includes attributes of the object 112 including garment type, color, prior ownership, and event-related data. The environmental inputs include ambient light, weather conditions, and location data associated with the object 112. The user interaction data includes gestures, movement, and pose associated with the garment and the user, and the multi-user context includes detection of one or more additional objects 112 associated with respective non-fungible tokens in proximity to the object 112.

In one embodiment, the computing device 102 is configured to enable cryptographically-gated augmented reality effects, wherein rendering of selected augmented reality content data is conditioned upon verification of ownership of the non-fungible token and validation of a physically-derived cryptographic signature associated with the smart tag 114. The system is further configured to perform an ephemeral cryptographic handshake between the smart tag 114, the user device 108, and the computing device 102. The ephemeral cryptographic handshake ensures that augmented reality content cannot be replicated or accessed using counterfeit tags. In one embodiment, the computing device 102 is further configured to perform optional updates associated with the non-fungible token on the blockchain network 106, including unlocking exclusive augmented reality content, special animations, and encrypted data accessible only upon successful authentication.

In one embodiment, the augmented reality content merges visuals, triggers collaborative mini-games or events, and updates visuals in real-time based on movement or joining or leaving participants. In one embodiment, the system provides non-fungible token provenance including minting, prior owners, and events in augmented reality. The system is configured to analyze user gestures, movement patterns, and preferences to adapt augmented reality animations or colors. The system is configured to include encrypted augmented reality messages or collectibles. The encrypted augmented reality messages or collectibles are accessible only to verified non-fungible token owners.

In one embodiment, the system is configured to activate augmented reality content only when all of the following conditions are satisfied. The conditions include verification of non-fungible token ownership on a blockchain network 106, determining whether environmental context matches one or more trigger rules, wherein the environmental context includes location, light, and ambient objects, detecting user gestures or motion using one or more sensors associated with the user device 108, detecting presence of nearby non-fungible token verified garments associated with one or more objects 112, and generating an ephemeral cryptographic token based on a physically-derived cryptographic signature associated with the smart tag 114.

In one embodiment, the system is configured to dynamically generate augmented reality overlays based on garment metadata, environmental input, social context, and user interaction data. The system is configured to utilize garment metadata including color, style, and non-fungible token history, environmental input including light, location, and motion, social context including multi-user interaction, and user preferences including past gestures and interaction patterns to generate augmented reality content.

FIG. 3 exemplarily illustrates a block diagram 300 of the computing device 102 and connection of the computing device 102 to the components of the system, according to an embodiment of the present invention. The computing device 102 comprises a processor 302 and a memory 304 in communication with the processor 302. The memory 304 stores a set of program modules including an input module 306, an authentication module 308, and an augmented reality module 310. The computing device 102 is in communication with the blockchain network 106, the database 104, the user device 108, the augmented reality device 110, and the smart tag 114 via the network 116.

The input module 306 is configured to receive a cryptographic code from the smart tag 114 via the user device 108 based on detection of the smart tag 114. The input module 306 is further configured to receive contextual data including environmental data, sensor data, and proximity data associated with one or more objects 112 from at least one user device 108.

The authentication module 308 is configured to verify ownership of a non-fungible token associated with the object 112 using the blockchain network 106. The authentication module 308 is further configured to validate the cryptographic code received from the smart tag 114 and evaluate the contextual data to determine whether predefined authentication conditions are satisfied.

The authentication module 308 is configured to perform verification of ownership of the non-fungible token using data stored in the blockchain network 106 including an identifier associated with the non-fungible token, provenance data including transaction history and ownership records, and metadata associated with the non-fungible token.

The augmented reality module 310 is configured to generate augmented reality content data associated with the object 112 upon satisfaction of the predefined authentication conditions. The augmented reality content data is context-aware and dynamically generated based on the contextual data, rules data, and user interaction data retrieved from the database 104.

The augmented reality module 310 is further configured to generate augmented reality broadcast information and transmit the augmented reality broadcast information to the user device 108. The augmented reality module 310 enables the user device 108 to initiate outward transmission of the augmented reality broadcast information via a wireless communication protocol including a short-range wireless communication protocol.

The augmented reality device 110 is configured to receive the augmented reality broadcast information from the user device 108 and render augmented reality content data relative to the object 112 based on spatial anchor data included in the augmented reality broadcast information.

In one embodiment, the augmented reality device 110 comprises AR glasses configured to continuously scan for augmented reality broadcast information from one or more nearby user devices 108, receive the augmented reality broadcast information comprising a cryptographic proof of ownership of the non-fungible token, extract and verify the cryptographic proof against the blockchain network 106 in real time, and discard augmented reality broadcast information that fails verification or is determined to be tampered.

The augmented reality device 110 is further configured to receive continuous positional update data associated with a broadcasting user device 108 and perform visual body pose estimation of a corresponding user using one or more imaging sensors. The augmented reality device 110 is configured to fuse the positional update data and the body pose estimation data to maintain spatial registration of augmented reality content relative to the object 112.

The augmented reality device 110 is configured to render augmented reality content only upon successful verification, wherein the augmented reality content is continuously anchored to one or more body keypoints of the corresponding user during movement, thereby maintaining spatial stability relative to the corresponding user independent of movement of the augmented reality device 110.

In one embodiment, the augmented reality device 110 is configured to detect augmented reality broadcast information from a plurality of user devices 108 in a shared environment, verify each broadcast based on a cryptographic proof associated with a corresponding non-fungible token, and rank verified broadcasts based on proximity of corresponding user devices 108.

The augmented reality device 110 is further configured to render augmented reality content data associated with broadcast signals within a predefined proximity threshold at a first rendering fidelity, adjust rendering of augmented reality content data beyond the predefined proximity threshold by reducing visibility, enforce visibility permissions associated with each broadcast, and render one or more additional augmented reality content layers based on permissions granted by a corresponding user associated with the non-fungible token.

In one embodiment, the smart tag 114 comprises a micro-strain lattice, an inertial measurement unit, environmental sensors, a physically unclonable function, and a processing module 120 configured as a cryptographic processor. The smart tag 114 is configured to compute a dynamic cryptographic identity by hashing combined outputs of the sensor node 126, the physically unclonable function, and a timestamp.

In one embodiment, the smart tag 114 is further configured to fuse the dynamic cryptographic identity with a hash associated with a non-fungible token to generate an ephemeral authentication token. The ephemeral authentication token is used for authentication of the object 112. The system is configured to condition rendering of augmented reality content upon simultaneous verification of the ephemeral authentication token and confirmation of ownership of the non-fungible token via the blockchain network 106. In one embodiment, the tamper detection module 122 of the smart tag 114 is configured to detect physical tampering, wherein upon detection of tampering, the smart tag 114 is configured to erase data associated with the physically unclonable function and initiate a transaction on the blockchain network 106 to update a status of the non-fungible token associated with the object 112 as quarantined.

In one embodiment, the system is configured to receive, at the user device 108, a successful authentication signal from the smart tag 114. The authentication signal comprises a verified ephemeral authentication token and proof of ownership of the non-fungible token.

The system is configured to activate, at the user device 108, an outward augmented reality broadcast into surrounding physical space via a wireless communication protocol including Bluetooth Low Energy or wireless direct communication. The system is configured to generate augmented reality broadcast information comprising a cryptographic proof of ownership of the non-fungible token, an augmented reality content identifier, spatial anchor data, and permission data defined by a user associated with the non-fungible token.

The system is configured such that the augmented reality broadcast information is passively detectable by one or more AR devices 110 without active scanning by an observer, wherein augmented reality content is spatially anchored relative to the user device 108 as the user device 108 moves. In one embodiment, the system is configured to broadcast a cryptographically verified augmented reality identity layer into surrounding physical space via the user device 108. The augmented reality identity layer is derived from verified ownership of a physical garment or a digital garment associated with a non-fungible token.

The system is configured such that the augmented reality identity layer is continuously detectable by nearby AR devices 110 without active scanning, wherein augmented reality content associated with the augmented reality identity layer is controlled and modifiable in real time by the user associated with the non-fungible token. The system is configured to enable the user associated with the non-fungible token to define permission data for the augmented reality broadcast information, including licensing display rights to one or more third parties for inclusion within the augmented reality content. The system is configured such that all augmented reality content associated with the augmented reality broadcast information is cryptographically attributable to and exclusively controlled by the verified owner of the non-fungible token, thereby preventing spoofing, unauthorized modification, or hijacking by third parties.

In one embodiment, the AR devices 110 comprise AR glasses configured to continuously scan for cryptographic augmented reality identity broadcasts from one or more nearby user devices 108 via a wireless communication protocol including Bluetooth Low Energy or wireless direct communication.

In one embodiment, the AR devices 110 are configured to, upon detection of the augmented reality broadcast information, automatically extract a cryptographic proof of ownership of a non-fungible token from the augmented reality broadcast information and verify the cryptographic proof against a record stored on the blockchain network 106 in real time without input from a user.

In one embodiment, the AR devices 110 are configured to render augmented reality content only upon successful verification of the cryptographic proof and to discard augmented reality broadcast information that is unverified or determined to be tampered.

In one embodiment, the AR devices 110 are configured to spatially anchor augmented reality content to a moving user associated with the user device 108 by receiving continuous positional update data from the user device 108.

In one embodiment, the AR devices 110 are further configured to perform visual body pose estimation of the user using one or more imaging sensors associated with the AR devices 110 and fuse the positional update data and pose estimation data to maintain spatial registration of augmented reality content relative to the user.

In one embodiment, the AR devices 110 are configured to continuously re-anchor augmented reality content to one or more identified body keypoints of the user as the user moves, thereby maintaining spatial stability of the augmented reality content independent of movement of the AR devices 110.

In one embodiment, the AR devices 110 are configured to manage simultaneous augmented reality broadcast information received from a plurality of user devices 108 in a shared environment.

The AR devices 110 are configured to detect and verify multiple concurrent augmented reality broadcast information signals, rank verified augmented reality broadcast information based on proximity of corresponding user devices 108, and render augmented reality content associated with broadcast signals within a predefined proximity threshold at a first rendering fidelity.

The AR devices 110 are further configured to adjust rendering of augmented reality content associated with broadcast signals beyond the predefined proximity threshold by reducing visibility, apply progressive opacity reduction or suppression, enforce permission data associated with each broadcast signal, and render one or more additional augmented reality content layers based on permissions granted by a corresponding user associated with a non-fungible token.

In one embodiment, the AR devices 110 are configured to detect spoofed augmented reality broadcast information by verifying a cryptographic proof of ownership of a non-fungible token against the blockchain network 106. The AR devices 110 are further configured to verify that the augmented reality broadcast information comprises a valid continuity token derived from a recent authentication event associated with the smart tag 114. The AR devices 110 are configured to flag augmented reality broadcast information as spoofed when the cryptographic proof is verified but the continuity token is invalid, and to discard the flagged augmented reality broadcast information without rendering augmented reality content.

In one embodiment, the AR devices 110 are configured to maintain spatial coherence of augmented reality content displayed relative to a moving user at variable viewing distances and angles. The AR devices 110 are configured to monitor viewing distance, angular offset, and rate of movement of the user associated with the user device 108, and trigger a spatial coherence correction process when one or more monitored parameters exceed a predefined threshold.

The AR devices 110 are further configured to re-project augmented reality content using updated geometry derived from body pose estimation data, adjust rendering resolution and edge definition based on viewing distance, and apply motion-predictive smoothing to maintain visual continuity. The AR devices 110 are configured such that the augmented reality content maintains stable visual quality relative to the user across variations in distance, viewing angle, and movement speed.

In another embodiment, a system for authentication of objects 112 and rendering augmented reality (AR) content relative to objects 112 is provided. The system comprises at least one object 112 comprising a smart tag 114. The object 112 is associated with a digital asset ownership record. As used herein, the term “digital asset ownership record” refers to a structured data record stored in a verification system including at least one of a blockchain network 106, a distributed ledger, or a centralized database. The digital asset ownership record is cryptographically or logically linked to a corresponding object 112 including a physical garment or a digital garment and is configured to represent ownership and identity of a digital asset associated with the object 112. The digital asset ownership record comprises at least an identifier associated with the digital asset, ownership information identifying a current owner, and provenance data including transaction history and ownership transfers. The smart tag 114 is configured to generate a cryptographic code at periodic intervals based on one or more parameters associated with the object 112 and a device fingerprint associated with the smart tag 114. The system 100 further comprises at least one user device 108 associated with the user and one or more augmented reality devices 110 configured to render augmented reality content relative to the object 112.

The system 100 comprises the database 104 configured to store augmented reality content data, rules data for generating augmented reality content, and user interaction data. The system 100 further comprises the computing device 102 in communication with the user device 108, the database 104, and a verification system via a network 116. The verification system comprises at least one of the blockchain network 106, a distributed ledger, and a centralized database configured to store the digital asset ownership record associated with the object 112.

The computing device 102 comprises a memory 304 storing a set of program modules and a processor 302 configured to execute the program modules. In one embodiment, the program modules comprise the input module 306 configured to receive the cryptographic code from the user device 108 based on detection of the smart tag 114. The input module 306 is further configured to receive contextual data including environmental data, sensor data, and proximity data associated with one or more objects 112 from at least one user device 108.

The program modules further comprise the authentication module 308 configured to verify ownership of the digital asset associated with the object 112 using the digital asset ownership record stored at the verification system. The authentication module 308 is further configured to determine whether predefined authentication conditions are satisfied based on validation of the cryptographic code, verification of the digital asset ownership record, and evaluation of the contextual data. The program modules further comprise the augmented reality module 310 configured to generate augmented reality content associated with the object 112 upon satisfaction of the predefined authentication conditions.

The augmented reality module 310 is further configured to generate augmented reality broadcast information comprising a cryptographic ownership proof, spatial anchor data, and permission data. The augmented reality module 310 is further configured to transmit the augmented reality broadcast information to the user device 108. The user device 108 is configured to initiate outward wireless transmission of the augmented reality broadcast information to one or more augmented reality devices 110 for rendering the augmented reality content relative to the object 112.

It is to be understood that although certain embodiments of the present invention are described with reference to non-fungible tokens and blockchain-based ownership records, the scope of the invention is not limited thereto. In various embodiments, ownership of an object 112 may be verified using any suitable digital ownership verification mechanism including, but not limited to, blockchain networks, non-fungible tokens, distributed ledgers, centralized databases, or other cryptographic or non-cryptographic ownership record systems. The authentication, augmented reality rendering, and broadcast mechanisms described herein are configured to operate based on verification of ownership irrespective of the underlying technology used to store or manage ownership records.

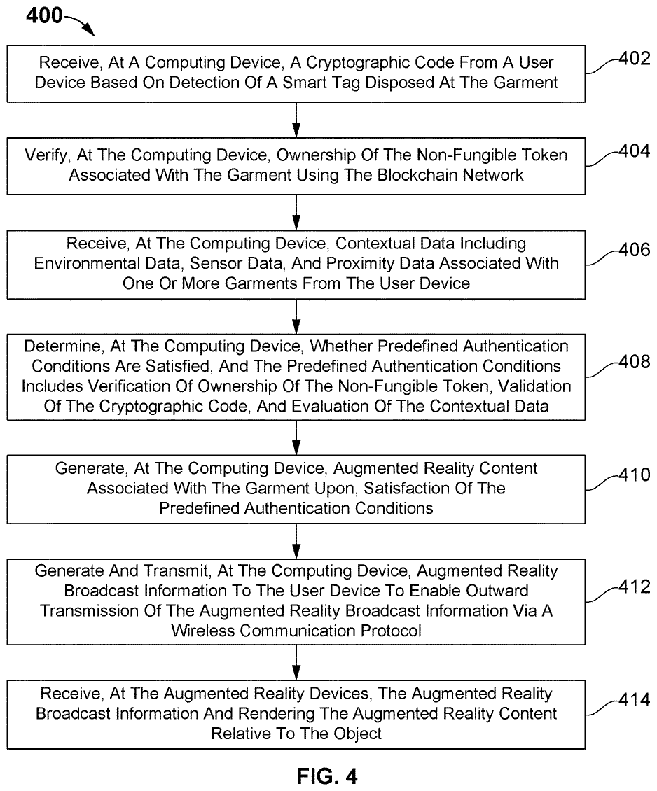

FIG. 4 exemplarily illustrates a flowchart 400 of a method for authentication of objects 112 and rendering augmented reality content relative to objects 112, according to an embodiment of the present invention. At step 402, the computing device 102 is configured to receive a cryptographic code from the user device 108 based on detection of the smart tag 114 disposed at the garment or object 112. The smart tag 114 is configured to generate a cryptographic code at periodic intervals based on physical movement of the garment, fabric texture, and a hardware fingerprint associated with the smart tag 114. The cryptographic code is dynamically updated and is not replicable, thereby preventing cloning of the smart tag 114. The smart tag 114 is further configured to detect tampering conditions and, upon detection of such conditions, erase stored cryptographic keys and transmit a tamper notification to update a status of the associated non-fungible token on the blockchain network 106 as compromised. The user device 108 detects the smart tag 114 via the identification element 124 and obtains the cryptographic code generated by the smart tag 114. In one embodiment, the cryptographic code from the user device 108 based on wireless detection of the smart tag 114 via a short-range communication interface including at least one of NFC, RFID, and BLE.

At step 404, the computing device 102 is configured to verify ownership of the non-fungible token associated with the object 112 using the blockchain network 106. The computing device 102 retrieves ownership data, provenance data, and metadata associated with the non-fungible token from the blockchain network 106 and performs verification.

At step 406, the computing device 102 is configured to receive contextual data including environmental data, sensor data, and proximity data associated with one or more garments or objects 112 from the user device 108. The contextual data is collected based on one or more sensors and inputs associated with the user device 108. The contextual data is captured by one or more sensors of the user device 108 including at least one of a camera, inertial measurement unit, and proximity sensor.

At step 408, the computing device 102 is configured to determine whether predefined authentication conditions are satisfied. The predefined authentication conditions include verification of ownership of the non-fungible token, validation of the cryptographic code received from the user device 108, and evaluation of the contextual data received from the user device 108.

At step 410, the computing device 102 is configured to generate augmented reality content associated with the object 112 upon satisfaction of the predefined authentication conditions. The augmented reality content is generated based on the rules data, user interaction data, and multi-user interaction data stored in the database 104, and is rendered as context-aware and dynamically generated content.

At step 412, the computing device 102 is configured to generate and transmit augmented reality (AR) broadcast information to the user device 108 to enable outward transmission of the augmented reality broadcast information via a wireless communication protocol. The user device 108 transmits the augmented reality broadcast information to one or more augmented reality devices 110. The AR broadcast information is transmitted without requiring active scanning by nearby devices, thereby enabling nearby augmented reality devices 110 to automatically receive the broadcast information and eliminating the need for short-range inward detection mechanisms.

At step 414, the augmented reality devices 110 are configured to receive the augmented reality broadcast information and render the augmented reality content relative to the object 112 via one or more display elements of the augmented reality devices 110 spatially aligned to the object 112. The augmented reality devices 110 process the broadcast information and display the augmented reality content in alignment with the spatial position of the object 112.

The method enables a user associated with the garment to control augmented reality content displayed relative to the user by managing the AR broadcast information transmitted to nearby augmented reality devices 110. The user device 108 is configured to allow selective authorization of display rights to third parties, including brands, for inclusion of additional augmented reality content within the broadcast. The augmented reality content rendering applies to both physical garments and digital garments associated with non-fungible tokens.

The augmented reality devices 110 are configured to automatically detect augmented reality broadcast information transmitted from nearby user devices 108, verify the broadcast information using cryptographic proofs associated with non-fungible tokens, and render augmented reality content relative to the corresponding garment. The augmented reality devices 110 maintain spatial anchoring of augmented reality content to a moving user, manage multiple simultaneous broadcasts in a shared environment, prevent rendering of unauthorized or fake broadcasts, and maintain augmented reality content quality across varying distances and viewing angles without distortion or loss of alignment.

What is claimed is:

1. A system for authentication of objects and rendering augmented reality content relative to objects, comprising:
at least one object comprises a smart tag, wherein the object is associated with a Non-Fungible Token (NFT), wherein the smart tag, optionally, comprises at least one sensor node, wherein the object comprises at least one of physical object and digital object, wherein the smart tag is configured to generate cryptographic code at periodic intervals based one or more parameters associated with the object and device fingerprint associated with the smart tag;
at least one user device associated with a user;
a database configured to store augmented reality content data associated with the object, rules data for generating augmented reality content, user interaction data and multi-user interaction data;
a blockchain network configured to store ownership data of the non-fungible token including an identifier associated with the non-fungible token, provenance data including transaction history and ownership records associated with the non-fungible token and metadata associated with the non-fungible token;
one or more augmented reality devices, and
a computing device in communication with the blockchain network, the database and the user device via a network, wherein the computing device comprises a memory storing a set of program modules and a processor configured to execute the program modules, wherein the program modules comprise:
an input module configured to receive the cryptographic code via the user device based on detection of the smart tag;
an authentication module configured to verify ownership of the non-fungible token associated with the object using the blockchain network;
the input module configured to receive contextual data including environmental data, sensor data, and proximity data associated with one or more objects from at least one user device;
the authentication module configured to determine whether predefined authentication conditions are satisfied, the predefined authentication conditions including verification of ownership of the non-fungible token, validation of the cryptographic code, and evaluation of the contextual data;
an augmented reality module configured to generate augmented reality content associated with the object upon satisfaction of the predefined authentication conditions, wherein the augmented reality content is context-aware and dynamically generated, and
an augmented reality module configured to generate and transmit an augmented reality (AR) broadcast information to the user device, wherein augmented reality module enables the user device to initiate outward transmission of an augmented reality (AR) broadcast information via a wireless communication protocol, wherein the AR devices is configured to receive AR broadcast information and render the augmented reality content data relative to the object.

2. The system of claim 1, wherein the wireless communication protocol is a short-range wireless communication protocol including Bluetooth Low Energy (BLE), wherein the object includes at least one of physical garment and digital garment, wherein the parameters include motion data, environmental data, characteristics data of the physical garment, wherein the sensor node is configured to capture the motion data, environmental data, characteristics data of the physical garment, and wherein the smart tag comprises a micro-strain lattice configured to capture fabric deformation data unique to the physical garment as an input to a cryptographic hash computation.

3. The system of claim 1, wherein the smart tag comprises a memory module storing a set of program modules and cryptographic data, and a processor configured to execute the program modules, wherein the program modules comprise a tamper detection module configured to detect a tampering condition associated with the smart tag, and in response to the tampering condition, erase stored cryptographic data and transmit a tamper notification for updating a status of the non-fungible token associated with the garment as compromised.

4. The system of claim 3, wherein the smart tag comprises at least one of a near field communication (NFC) tag, a radio frequency identification (RFID) tag, a Bluetooth low energy (BLE) transmitter, and a quick response (QR) code associated with the garment, wherein the smart tag is configured to emit optical markers and magnetic signals to generate a spatially detectable identity field associated with the garment, and wherein the computing device is configured to detect the spatially detectable identity field to localize the augmented reality content relative to the garment via the user device, wherein the augmented reality (AR) broadcast information includes spatial anchor data to localize the augmented reality content relative to the garment.

5. The system of claim 1, wherein the computing device enables the user device to at least one of continuously and periodically transmit augmented reality (AR) broadcast information to one or more AR devices proximal to the user device, wherein the AR broadcast information includes a cryptographic proof of ownership of a non-fungible token, the augmented reality content data, spatial anchor data and permission data.

6. The system of claim 1, wherein upon authentication of the user, wherein the computing device enables the user device to control and modify the AR content data displayed relative to the garment in real time, and allow the user to selectively define one or more AR content data to be broadcast to nearby AR devices, wherein the rendering of the AR content data applies to both physical garments and digital garments.

7. The system of claim 1, wherein an augmented reality device comprises AR glasses configured to:
continuously scan for AR broadcast information from one or more nearby user devices via short-range wireless communication;
receive the AR broadcast information comprising a cryptographic proof of ownership of the non-fungible token;
extract and verify the cryptographic proof against a blockchain record in real time without user input;
discard AR broadcast signals that fail verification or are determined to be tampered;
receive continuous positional update data associated with a broadcasting user device;
perform visual body pose estimation of a corresponding user wearing the garment using one or more onboard imaging sensors;
fuse the positional update data and the body pose estimation data to maintain spatial registration, and
render augmented reality content only upon successful verification, wherein the augmented reality content is continuously anchored to one or more body keypoints of the corresponding user during movement, thereby maintaining spatial stability relative to the corresponding user independent of movement of the augmented reality device.

8. The system of claim 1, wherein an augmented reality device comprises AR glasses configured to:
detect AR broadcast signals from a plurality of user devices in a shared environment;
verify each broadcast signal based on a cryptographic proof associated with a corresponding non-fungible token;
rank verified broadcast signals based on proximity of corresponding user devices;
render augmented reality content data associated with broadcast signals within a predefined proximity threshold at a first rendering fidelity;
adjust rendering of augmented reality content data associated with broadcast signals beyond the predefined proximity threshold by reducing visibility;
enforce visibility permissions associated with each broadcast signal based on permission data, and
render one or more additional AR content layers within a spatial region associated with each broadcast signal based on permissions granted by a corresponding user of the non-fungible token.

9. The system of claim 1, wherein the authentication module is configured to perform zero-knowledge proof based verification of ownership of the non-fungible token to confirm ownership without revealing wallet identity information associated with the user.

10. The system of claim 1, wherein the AR module is configured to dynamically generate augmented reality content based on garment metadata, environmental data, and user interaction history associated with the user device, wherein the computing device is further configured to detect proximity of one or more additional garments associated with respective non-fungible tokens and generate interactive augmented reality content data based on multi-user interaction between the garments via the AR module, and wherein the augmented reality content data comprises collaborative visual effects generated when two or more garments associated with verified non-fungible tokens are detected within a predefined proximity region.

11. The system of claim 1, wherein the augmented reality devices are configured to:
detect spoofed augmented reality broadcast information by verifying a cryptographic proof of ownership of a non-fungible token against the blockchain network;
verify that the augmented reality broadcast information comprises a valid continuity token derived from a recent authentication event associated with the smart tag;
flag the augmented reality broadcast information as spoofed when the cryptographic proof is verified but the continuity token is invalid, and discard the flagged augmented reality broadcast information without rendering augmented reality content;
maintain spatial coherence of augmented reality content displayed relative to a moving user at variable viewing distances and angles, monitor viewing distance, angular offset, and rate of movement of the user associated with the user device, and trigger a spatial coherence correction process when one or more monitored parameters exceed a predefined threshold, and
re-project augmented reality content using updated geometry derived from body pose estimation data, adjust rendering resolution and edge definition based on viewing distance, apply motion-predictive smoothing to maintain visual continuity, and maintain stable visual quality of the augmented reality content relative to the user across variations in distance, viewing angle, and movement speed.

12. A method for authentication of objects and rendering augmented reality (AR) content relative to objects, comprising:
providing at least one object comprising a smart tag, at least one user device associated with a user, a database, a blockchain network, one or more augmented reality devices, and a computing device in communication with the blockchain network, the database and the user device via a network, wherein the object comprises at least one of a physical object and a digital object and is associated with a non-fungible token, wherein the smart tag is configured to generate a cryptographic code at periodic intervals based on one or more parameters associated with the object and a device fingerprint associated with the smart tag, wherein the computing device comprises a memory storing a set of program modules and a processor configured to execute the program modules;
receiving, at the computing device via an input module, the cryptographic code from the user device based on wireless detection of the smart tag via a short-range communication interface;
verifying, at the computing device via an authentication module, ownership of the non-fungible token associated with the object using the blockchain network;
receiving, at the computing device via the input module, contextual data including environmental data, sensor data, and proximity data associated with one or more objects captured by one or more sensors of the user device including at least one of a camera, inertial measurement unit, and proximity sensor;
determining, at the computing device via the authentication module, whether predefined authentication conditions are satisfied, the predefined authentication conditions including verification of ownership of the non-fungible token, validation of the cryptographic code, and evaluation of the contextual data;
generating, at the computing device via an augmented reality module, augmented reality content associated with the object upon satisfaction of the predefined authentication conditions, wherein the augmented reality content is context-aware and dynamically generated;
generating and transmitting, at the computing device via the augmented reality module, augmented reality broadcast information to the user device to enable outward transmission of the augmented reality broadcast information via a wireless communication protocol, and
receiving, at the augmented reality devices, the augmented reality broadcast information and rendering the augmented reality content relative to the object via one or more display elements of the augmented reality devices.

13. The method of claim 12, wherein the object comprises at least one of a physical garment and a digital garment, and wherein the parameters include motion data, environmental data, and characteristics data of the physical garment, and wherein the method further comprises capturing, by the smart tag, the motion data, environmental data, and characteristics data of the physical garment using one or more embedded sensors including an inertial measurement unit and environmental sensing elements.

14. The method of claim 12, further comprising the steps of: detecting, by the smart tag, a tampering condition associated with the smart tag, and in response to the tampering condition, erasing stored cryptographic data and transmitting a tamper notification for updating a status of the non-fungible token as compromised.

15. The method of claim 12, wherein the smart tag comprises at least one of a near field communication tag, a radio frequency identification tag, a Bluetooth Low Energy transmitter, and a quick response code, and wherein the method further comprises the steps of: emitting optical markers and magnetic signals to generate a spatially detectable identity field associated with the object, and detecting the spatially detectable identity field to localize the augmented reality content relative to the object, wherein the augmented reality broadcast information comprises spatial anchor data, wherein the spatially detectable identity field is detected.

16. The method of claim 12, further comprising the step of transmitting, by the user device, the augmented reality broadcast information via a wireless radio transceiver continuously or periodically to one or more augmented reality devices proximal to the user device, wherein the augmented reality broadcast information comprises a cryptographic proof of ownership of the non-fungible token, augmented reality content data, spatial anchor data, and permission data, and enabling, by the computing device, the user device to control and modify the augmented reality content data in real time via a graphical user interface rendered on a display of the user device and selectively define one or more augmented reality content data to be broadcast to nearby augmented reality devices.

17. The method of claim 12, further comprising the steps of:
detecting, by an augmented reality device, augmented reality broadcast information from one or more nearby user devices;
receiving, by the augmented reality device, the augmented reality broadcast information comprising a cryptographic proof of ownership of the non-fungible token;
verifying, by the augmented reality device, the cryptographic proof using blockchain data;
discarding, by the augmented reality (AR) device, augmented reality broadcast signals that fail verification;
receiving, at the AR device, positional update data associated with the user device;
performing, at the AR device, body pose estimation of a user wearing the object using one or more onboard imaging sensors, and rendering, at the AR device, augmented reality content anchored to one or more body keypoints of the user based on fusion of positional data and body pose estimation data.

18. The method of claim 12, further comprising the steps of:
detecting, by an augmented reality device, augmented reality broadcast signals from a plurality of user devices;
verifying, at the augmented reality device, each broadcast signal based on a cryptographic proof associated with a corresponding non-fungible token;
ranking, at the augmented reality device, verified broadcast signals based on proximity;
rendering, at the augmented reality device, augmented reality content within a predefined proximity threshold at a first rendering fidelity;
reducing, at the augmented reality device, visibility of augmented reality content beyond the predefined proximity threshold;
enforcing, at the augmented reality device, visibility permissions associated with each broadcast signal, and rendering, at the augmented reality device, additional augmented reality content layers based on permissions associated with each broadcast signal.

19. The method of claim 12, further comprising the steps of:
performing, by the authentication module, zero-knowledge proof based verification of ownership of the non-fungible token without revealing wallet identity information;
dynamically generating, by the augmented reality module, augmented reality content based on garment metadata, environmental data, and user interaction history, and
detecting proximity of one or more additional garments associated with respective non-fungible tokens and generating interactive augmented reality content based on multi-user interaction between the garments.

20. A system for authentication of objects and rendering augmented reality (AR) content relative to objects, comprising:
at least one object comprising a smart tag, wherein the object is associated with a digital asset ownership record, wherein the smart tag is configured to generate a cryptographic code at periodic intervals based on one or more parameters associated with the object and a device fingerprint associated with the smart tag;
at least one user device associated with a user;
one or more augmented reality devices;
a database configured to store augmented reality content data, rules data for generating augmented reality content, and user interaction data, and
a computing device in communication with the user device, the database, and a verification system via a network, wherein the verification system comprises at least one of a blockchain network, a distributed ledger, and a centralized database configured to store the digital asset ownership record;
wherein the computing device comprises a memory storing program modules and a processor configured to execute the program modules, wherein the program modules comprise:
an input module configured to receive the cryptographic code from the user device based on detection of the smart tag;
an authentication module configured to verify ownership of the digital asset associated with the object using the digital ownership record at the verification system;
the input module configured to receive contextual data including environmental data, sensor data, and proximity data associated with one or more objects from at least one user device;
the authentication module configured determine whether predefined authentication conditions are satisfied based on validation of the cryptographic code, the verification of digital asset ownership record, and the contextual data;
an augmented reality module configured to generate augmented reality content associated with the object upon satisfaction of the predefined authentication conditions;
the augmented reality module configured to generate augmented reality broadcast information comprising at least a cryptographic ownership proof, spatial anchor data, and permission data, and
the augmented reality module configured to transmit the augmented reality broadcast information to the user device to enable outward wireless transmission to one or more augmented reality devices for rendering the augmented reality content relative to the object.
